(19) United States
(12) Patent Application Publication
(10) Pub. No.: US 2022/0315774 A1
(43) Pub. Date: Oct. 6, 2022

(54) Multi-Functional Material for EMI Shielding and Structural Health Monitoring of Carbon Fiber Reinforced Plastics

(71) Applicant: UT-Battelle, LLC, Oak Ridge, TN (US)

(72) Inventors: Vipin Kumar, Oak Ridge, TN (US); Justin C. Condon, Oak Ridge, TN (US); Ahmed A. Hassen, Oak Ridge, TN (US); Christopher J. Hershey, Oak Ridge, TN (US); Seokpum Kim, Oak Ridge, TN (US); Vlastimil Kunc, Oak Ridge, TN (US); John M. Lindahl, Oak Ridge, TN (US)

(21) Appl. No.: 17/708,088

(22) Filed: Mar. 30, 2022

Related U.S. Application Data
(60) Provisional application No. 63/167,767, filed on Mar. 30, 2021.

(51) Int. Cl. C09D 5/24; C08L 65/02; C08L 79/02; H01B 1/12; C08L 101/12; H01B 1/20

(52) U.S. Cl. CPC C09D 5/24; C08L 65/02; C08L 79/02; H01B 1/128; C08L 101/12; H01B 1/20

(57) ABSTRACT

A polymeric adhesive film including a conductive filler of polyaniline (PANI) and MXene is provided. The adhesive film can be painted, printed, or applied to different substrate structures, including aircraft and wind turbine blades. The adhesive film has potential as a fatigue sensor, a strain sensor, a gas sensor, a humidity sensor, and a temperature sensor, by non-limiting example. In one embodiment, a force sensing material includes a conductive filler of PANI and MXene within an organic or polymer matrix. The force sensing material is used to measure local mechanical strain by detecting the change in electrical conductivity induced by the mechanical strain. The force sensing material can also be used in other applications where local strain changes, including the detection of local humidity and local temperature.

### CROSS-REFERENCE TO RELATED APPLICATIONS

This application claims the benefit of U.S. Provisional Application 63/167,767, filed Mar. 30, 2021, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a multi-functional material for electromagnetic interference (EMI) shielding and structural health monitoring of carbon fiber reinforced plastics (CFRPs).

### BACKGROUND OF THE INVENTION

Carbon fiber reinforced plastics are increasingly used in the manufacture of aircraft structures (e.g., fuselage, wings, empennage) and wind turbines blades. Over the course of normal operations, however, these structural components experience repeated mechanical loads. For example, the mechanical performance of CFRP composite structures severely degrades when even micro-damage is present. As a result, these structural components are carefully monitored for early signs of fatigue failure, typically through the use of strain sensors.

Polyaniline (PANI) has been proposed as lightning strike protection for wind turbine blades by K. Vipin et al. in “Polyaniline-based all-polymeric adhesive layer: An effective lightning strike protection technology for high residual mechanical strength of CFRPs” in Composites Science and Technology 172 (2019). PANI has good electrical, physical, and chemical properties, which make it promising for other applications as well. For example, PANI has been studied as a filler for flexible strain sensors by P. Costa et al. in “Piezoresistive polymer blends for electrochemical sensor applications,” Composites Science and Technology 168 (2018). In their work, they reported doped PANI mixed with elastomer styreneethylene/butylene-styrene (SEBS) for large strain sensing applications. Their work reported a high electrical conductivity (1 S/m) with a gauge factor of 1.5 to 2.4 for a deformation of up to 10%.

There remains a continued need to improve PANI-based sensing for CFRP structures. A wide variety of sensors are in modern use for detecting not only fatigue stresses on aircraft structures and wind turbine blades, but also temperature, humidity, strain, and vibration. Presently, a multifunctional material with the capability to perform many of these functions is rigorously being sought. A multi-functional sensor could achieve weight savings and reduce complexity by consolidating all or some of these sensors into a single design, which would also reduce the presence of sensor wiring and wiring harnesses within the airframe or wind turbine.

### SUMMARY OF THE INVENTION

A multi-functional material including a conductive filler within a polymer matrix is provided. The conductive filler includes MXene powders and a conductive polymer, for example polyaniline (PANI). The multi-functional material can be painted, printed, or otherwise applied to different CFRP substrates, and the multi-functional material can be used as a fatigue sensor, a strain sensor, a gas sensor, a humidity sensor, and a temperature sensor, by example.

In one embodiment, the multi-functional material is a force sensing material including a conductive filler of PANI and MXene within a polymer matrix. The force sensing material is used to measure local mechanical strain by detecting a change in electrical conductivity. The multi-functional material can also be used in other applications involving local strain changes, including the detection of local humidity and local temperature. PANI and MXene provide a highly conducive filler with very good dispersibility in many organic polymers. The combination of PANI, as a positive charge carrier, and MXene, as a negative charge carrier, form a three-dimensional electrically conductive network. The desired thickness, printing direction, and electrical path can be designed for the particular application, including the structural health monitoring of load-bearing CFRP structures for aircraft and wind turbines, while also providing electromagnetic shielding by weakening incoming electromagnetic waves.

These and other features of the invention will be more fully understood and appreciated by reference to the description of the embodiments and the drawings.

### BRIEF DESCRIPTION OF THE DRAWINGS

FIG. 1 shows an example of a multi-functional material disposed on a substrate as a strain sensing material.

FIG. 2 shows a strain sensor as a Wheatstone bridge for use with the multi-functional material of FIG. 1.

FIG. 3 is a graph illustrating the change in electrical conductivity (resistance) of the multi-functional material over time as a function of an applied tensile load.

### DETAILED DESCRIPTION OF THE CURRENT EMBODIMENTS

The current embodiments relate to a multi-functional material including a conductive filler, the conductive filler including MXene particles and a conductive polymer, for example polyaniline. The multi-functional material can be painted, printed, or otherwise adhered to different substrate structures, including aircraft and wind turbine blades. The multi-functional material can function as a fatigue sensor, a strain sensor, a gas sensor, a humidity sensor, and a temperature sensor, by example, while also providing electromagnetic interference shielding for the underlying structure. The desired thickness, printing direction, and electrical path can be designed for the particular application, including the structural health monitoring of carbon fiber reinforced plastics.

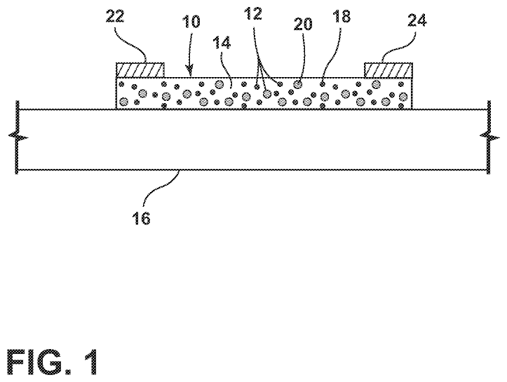

FIG. 1 illustrates one embodiment of the multi-functional material, generally designated 10. The multi-functional material 10 includes a conductive filler 12 dispersed within a polymer matrix 14. The multi-functional material 10 is deposited on a substrate 16 to form a variable resistor. The substrate 16 is optionally a carbon fiber reinforced plastic (CFRP), for example a surface of an aircraft (e.g., wing, fuselage, empennage, aileron, rudder) or a surface of a wind turbine (e.g., wind turbine blade). Other supporting substrates include metals and metal alloys. It should be noted that FIG. 1 is not drawn to scale, and in practice the thickness of the multi-functional material 10 will be much less than the thickness of the substrate 16.

The polymer matrix 14 can include common polymeric materials including, but not limited to, at least one repeating unit of an epoxy, a carbonate, an acrylic, a silicone, or a urethane.

The polymer matrix 14 can be cured by heat, light, or the combination of heat and light. The polymer matrix 14 can include other functional ingredients such as a cross-linker, a plasticizer, a dispersant, a viscosity modifier, and/or an adhesion promoter.

The conductive filler 12 includes a plurality of MXene particles 18 and at least one conductive polymer 20, for example PANI. Alternative conductive polymers include polypyrrole, polythiophene, polyacetylene, or polyphenylene. MXenes comprise highly-conductive two-dimensional transition metal carbides and nitrides. MXenes have the general formula of Mₙ₋₁XₙT_{z}, where M is an early transition metal (e.g., Ti, V, Cr, Nb, Mo), X is carbon and/or nitrogen, and T_{z} is a functional group (e.g., O, OH, and F). MXenes are known to possess high electrical conductivity, up to 2.4×10⁴ S/cm, and are hydrophilic because of the presence of the aforementioned functional groups. Further, as PANI is positively charged and MXene is negatively charged, a strong electrostatic bond enhances adhesion between PANI and MXene. The combination of PANI, as a positive charge carrier, and MXene, as a negative charge carrier, provide the ability to form a three-dimensional electrically conductive network for strain sensing.

The MXene particles 18 can include flakes, platelets, powders, granules, or combinations thereof. The weight percentage of the conductive filler within the polymer matrix can be larger than 1 wt. %, optionally greater than 20 wt. %, further optionally greater than 30 wt. %. MXenes can be present in the polymer matrix at 1-20 wt. %, optionally 1-10 wt. %, further optionally 2 wt. %. The multi-functional material 10 can be directly joined to a CFRP structure 16, such that an elastic carrier (backing) is not required. For example, the multi-functional material 10 can be deposited, attached, or bonded to the CFRP structure 16 to form a variable resistor. The multi-functional material 10 can be applied by coating processes such as spin coating, slot die coating, screen printing, or inkjet printing, by non-limiting example.

First and second electrodes 22, 24 are spaced apart from each other along the multi-functional material 10 to measure the electrical resistance of the multi-functional material 10 as a function of an applied load. The first and second electrodes 22, 24 can be printed on the top side of the multi-functional material 10, opposite of the substrate 16. Alternatively, the first and second electrodes 22, 24 can be printed on the bottom side of the multi-functional material 10, such that the electrodes 22, 24 are between the multi-functional material 10 and the substrate 16.

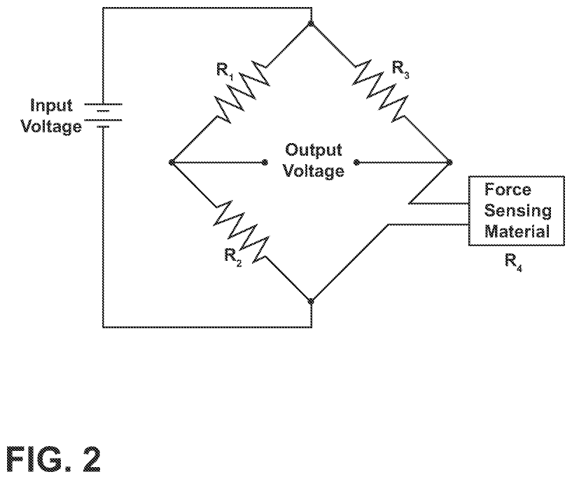

In use, a strain sensor measures the linear deformation (surface strain) occurring in the multi-functional material 10 during loading (typically compression or tension) of the underlying substrate 16. The strain sensor can operate by use of a DC current through the multi-functional material 10 via the first and second electrodes 22, 24. For example, the strain sensor (a) detects a change in the electrical resistance of the multi-functional material 10 in response to an external force on the underlying substrate 16, wherein the change is generated as an output voltage, and (b) determines, from the output voltage, the strain in the underlying substrate 16 caused by the external force. The first and second electrodes 22, 24 can be electrically connected to a Wheatstone bridge circuit, shown in FIG. 2. In particular, one arm of the Wheatstone bridge circuit is replaced by a variable resistor comprising the multi-functional material 10 of FIG. 1. The output voltage is a function of the resistance of the multi-functional material (R₄) according to the following equation, where the remaining resistors (R₁, R₂, R₃) are reference resistors:

$${V}_{out} = {V}_{i n} \cdot [ \frac{{R}_{4}}{{R}_{3} + {R}_{4}} - \frac{{R}_{2}}{{R}_{1} + {R}_{2}} ]$$

With the output voltage known, the strain E can be calculated according to the following equation, in which GF is the gauge factor (typically 2.0) of the strain sensor:

$$ϵ = ( \frac{4}{G F} ) \cdot ( \frac{{V}_{out}}{{V}_{i n}} )$$

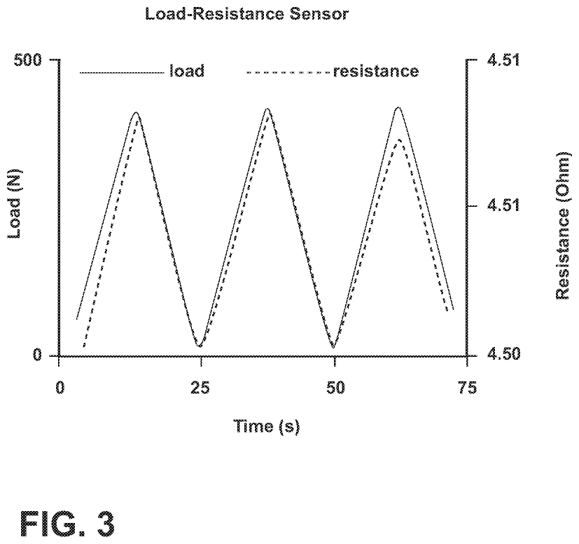

The change in electrical conductivity of the multi-functional material 10 over time is plotted in FIG. 3, and a direct relation between a load (tensile) and deflection is obtained in real time. High linearity of the change in electrical conductivity of the multi-functional material 10 against the applied load makes the multi-functional material well-suited for strain sensing applications. Dynamic loading of the underlying structure can lead to fatigue and creep failure, and consequently the in-situ structural health monitoring of the underlying structure can lead to early detection of structural faults. The multi-functional material 10 is not limited to the measure of local mechanical strain, and can be used in other applications as desired. For example, the multi-functional material can also be used in the detection of local humidity, local temperature, and vibration.

An example method for forming the multi-functional material 10 will now be described. The multi-functional material 10 can be formed by (a) combining a plurality of MXene particles and a phenol resin to form a first mixture, (b) combining a conductive polymer (e.g., PANI) and a curing agent (e.g., dodecyl benzene sulfonic acid (DBSA)) to form a second mixture, and (c) combining the first mixture with the second mixture to achieve a conductive filler that is dispersed in a polymer matrix, wherein the conductive filler includes the plurality of MXene particles and the conductive polymer. Each step is separately discussed below.

Forming the first mixture includes combining a plurality MXene particles and a phenol resin. The plurality of MXene particles include powders, flakes, platelets, granules, or combinations thereof. The MXene particles can be obtained by delamination (chemical etching) from a MXene precursor, for example Ti₃AlC₂, using a solvent, for example divinylbenzene (DVB). DVB is advantageous because, as discussed below, DVB is also a cross-linking agent. Consequently, a MXene-DVB suspension can be directly converted into a thermosetting structural composite without intermediate processing. In other embodiments, MXene particles can be added to a solution of DVB (or other cross-linking agent) to create the first mixture.

Forming the second mixture includes combining a conductive polymer with a curing agent. The conductive polymer can include one or more of the following, by non-limiting example: polyaniline, polypyrrole, polythiophene, polyacetylene, or polyphenylene. Additional conductive fillers can include for example carbon nanotubes, graphene, and carbon black. The curing agent includes dodecyl benzene sulfonic acid (DBSA) in the current embodiment, however other curing agents can be used in other embodiments as desired. DBSA acts as a cationic scavenger and helps in the controlled curing of the cross-linking agent DVB, which otherwise undergoes an uncontrolled exothermic reaction when cured with unbounded protic acids.

Combining the first mixture with the second mixture results in a thermosetting compound, which can be applied to a substrate and cured. The thermosetting compound can be applied using printing techniques such as spin-coating, spray coating, screen printing, dip-coating, slot-die printing, and ink-jet printing. Alternatively, the multi-functional material 10 can formed and subsequently affixed to the substrate 16 with an epoxy resin that is interposed between the multi-functional material 10 and the substrate 16. The multi-functional material 10 can be processed at or near room temperature as an electrically conductive health monitoring sensor with EMI shielding. Functional ingredients can be added to the first or second mixtures, including for example a viscosity modifier, an adhesion promoter, a plasticizer, or a cross-linker.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A sensor comprising:
a force-sensing material including a conductive filler dispersed in a polymer matrix; and
two or more electrodes at spaced locations of the force-sensing material, wherein the conductive filler includes a plurality of MXene particles.

2. The sensor of claim 1, wherein the plurality of MXene particles are present in the force-sensing material at 1 wt. % to 10 wt. %, inclusive

3. The sensor of claim 1, wherein the conductive filler further comprises a plurality of conductive polymers.

4. The sensor of claim 3, wherein the plurality of conductive polymers are selected from the group consisting of polyaniline, polypyrrole, polythiophene, polyacetylene, or polyphenylene.

5. The sensor of claim 4, wherein the conductive polymer is present in the composition at 10 wt. % to 30 wt. %, inclusive.

6. The sensor of claim 1, wherein the plurality of MXene particles comprise powders, flakes, platelets, granules, or combinations thereof.

7. The sensor of claim 1, wherein the plurality of MXene particles include Ti₃C₂.

8. The sensor of claim 1, wherein the force-sensing material is free of any metal fillers.

9. A method for measuring strain in a structure, the method comprising:
applying a force-sensing material to the structure, the force-sensing material includes a plurality of MXene particles dispersed in a polymer matrix;
detecting a change in electrical resistance of the force-sensing material in response to an external force on the structure, wherein the change is generated as an output voltage; and
determining, from the output voltage, the strain in the structure caused by the external force on the structure.

10. The method of claim 9, further including two or more electrodes at spaced locations of the force sensing material.

11. A force-sensing material comprising:
a conductive filler including a plurality of MXene particles;
wherein the conductive filler is dispersed in a polymer matrix.

12. The force-sensing material of claim 11, wherein the plurality of MXene particles are present in the composition at 1 wt. % to 10 wt. %, inclusive

13. The force-sensing material of claim 11, wherein the conductive filler further comprises a plurality of conductive polymers.

14. The force-sensing material of claim 13, wherein the plurality of conductive polymers are selected from the group consisting of polyaniline, polypyrrole, polythiophene, polyacetylene, or polyphenylene.

15. The force-sensing material of claim 14, wherein the conductive polymer is present in the composition at 10 wt. % to 30 wt. %, inclusive.

16. The force-sensing material of claim 11, wherein the plurality of MXene particles comprise powders, flakes, platelets, granules, or combinations thereof.

17. The force-sensing material of claim 11, wherein the plurality of MXene particles include Ti₃C₂.

18. The force-sensing material of claim 11, wherein the conductive filler is free of any metal fillers.

19. A resistive force sensor comprising the force-sensing material of claim 11.

20. The resistive force sensor of claim 19, wherein the force sensing material comprises a variable resistor of a Wheatstone bridge.
